(19) United States
(12) Patent Application Publication
(10) Pub. No.: US 2026/0326080 A1
(43) Pub. Date: Oct. 22, 2026

(54) COMPOSITE PARTICLES AND USES THEREOF

(71) Applicant: Virginia Tech Intellectual Properties, Inc., Blacksburg, VA (US)

(72) Inventors: Rebecca M.D. Martin, Blacksburg, VA (US); Louis A. Madsen, Blacksburg, VA (US); Nicholas F. Pietra, Blacksburg, VA (US)

(21) Appl. No.: 19/652,273

(22) Filed: Apr. 20, 2026

Related U.S. Application Data
(60) Provisional application No. 63/792,376, filed on Apr. 22, 2025.
(60) Provisional application No. 63/894,839, filed on Oct. 7, 2025.

(51) Int. Cl. B01J 20/22; B01D 53/04; B01J 20/28; B01J 20/292; B01J 20/30; B01J 20/32

(52) U.S. Cl. CPC B01J 20/22; B01D 53/0423; B01D 53/0438; B01J 20/28007; B01J 20/28016; B01J 20/292; B01J 20/3092; B01J 20/3212; B01J 20/3214; B01J 20/3287; B01J 20/3293; B01D 2253/202; B01D 2253/25; B01D 2257/504; B01D 2258/0283; B01D 2259/40088; B01D 2259/4508

(57) ABSTRACT

A composition includes a plurality of composite microparticles. The composite microparticles include particular amounts of a sulfonated polyaramid and an ionic liquid. The compositions can be particularly useful in the sorption of a target gas from a gas stream. Accordingly, methods and systems for capture of a target gas represent another aspect of the present disclosure.

### CROSS REFERENCE TO RELATED APPLICATIONS

The present application claims priority to and the benefit of U.S. Provisional Patent Application No. 63/792,376, filed on Apr. 22, 2025, and U.S. Provisional Patent Application No. 63/894,839, filed on Oct. 7, 2025, the contents of both of which are hereby incorporated by reference in their entirety.

### FEDERAL RESEARCH STATEMENT

This invention was made with government support under Grant No. DMR-1810194 awarded by the National Science Foundation Division of Materials Research (NSF DMR). The government has certain rights in the invention.

### BACKGROUND

Gas separation processes are critical to a wide range of industrial and environmental applications, including carbon capture and sequestration (CCS), air purification for human-occupied environments such as spacecraft and submarines, and natural gas processing. Among these, the separation of carbon dioxide (CO₂) from mixed gas streams is of particular importance due to its role in mitigating greenhouse gas emissions. A major source of CO₂ emissions is flue gas, which is generated from the combustion of fossil fuels such as coal, natural gas, and oil. Flue gas typically contains nitrogen, CO₂, and water vapor, along with trace contaminants such as sulfur oxides and nitrogen oxides. Industrial processes including cement, asphalt, and steel production are also large point-source emitters of CO₂-heavy flue gas. Effective separation of CO₂ from flue gas represents a significant challenge and an urgent need to reduce atmospheric CO₂ levels.

Current CO₂ capture technologies, including zeolite-based adsorbents and liquid amine systems, suffer from limitations such as low CO₂ uptake capacity, high energy requirements for regeneration, and sensitivity to moisture. These drawbacks underscore the need for alternative separation technologies that are cost-effective, energy-efficient, and durable under operating conditions. The development of such technologies is not only critical for environmental sustainability but also represents a rapidly growing market.

Accordingly, there remains a need in the art for improved compositions, methods, and systems for selectively separating target gases, such as CO₂, from mixed gas streams. It would be particularly advantageous to provide materials with tunable properties to enable the capture of a broad range of gases beyond CO₂, while maintaining high selectivity, capacity, and regenerability under practical operating conditions.

### SUMMARY

An aspect of the present disclosure is a composition comprising a plurality of composite microparticles, each composite microparticle of the plurality of composite microparticles comprising: 1 to 30 weight percent of a sulfonated polyaramid; and 70 to 99 weight percent of an ionic liquid; wherein weight percent is based on the total weight of the composite microparticle.

Another aspect is a method for the manufacture of the composition, the method comprising: heating a composite hydrogel comprising: the sulfonated polyaramid; the ionic liquid; and water; to a temperature effective to fluidize the composite hydrogel; combining the fluidized composite hydrogel with an organic phase under conditions effective to provide an emulsion comprising a dispersed phase comprising the composite hydrogel and a continuous phase comprising the organic phase; cooling the emulsion to form a dispersion of hydrogel particles; isolating the hydrogel particles from the emulsion; and exposing the hydrogel particles to an excess of ionic liquid to provide a composition comprising a plurality of composite microparticles.

Another aspect is a method of capturing a target gas from an input gas stream, the method comprising: exposing the input gas stream comprising the target gas to the composition to provide a product gas stream, wherein the product gas stream has a concentration of the target gas that is less than a concentration of the target gas in the input gas stream.

Another aspect is a gas separation system comprising: a column comprising a gas inlet at a first end and a gas outlet at the second, opposite end of the column; wherein the column comprises a packed bed comprising the composition.

The above described and other features are exemplified by the following figures and detailed description.

### BRIEF DESCRIPTION OF THE DRAWINGS

The following figures are exemplary embodiments.

FIG. 1 shows chemical structures of exemplary components in MIC particles including ionic liquid cation and anion components, polymer, and solvent.

FIG. 2 shows ¹³C Decoupled Quantitative NMR (zgpg) of pure EMImTfO IL samples (left) compared to a MIC (right) doped with CO₂ with chemical shift, δ, assignments. All samples incorporated 15 mM Cr(AcAc)₃ relaxation agent in the IL. The integrated CO₂ signal is compared to the TfO signals, which are unaffected by NOE, for molar quantification determination of the CO₂ loading in the IL. The pure IL samples exhibit different concentrations of CO₂. Line width broadening is evident in the MIC sample due to the IL confinement in the solid structure. NS=512.

FIG. 3 shows diffusion of all mobile species for solid MIC and pure liquid IL as a function of absorbed CO₂ concentration (IL=EMImTfO).

FIG. 4 is a schematic illustration of design and testing of MIC particles for CO₂ removal from a gas stream.

FIG. 5 shows polarized optical microscopy images of a MIC hydrogel (left) and MIC particles (right) from emulsion processing with EMImTfO IL.

FIG. 6 shows a plot of CO₂ absorption capacity (mmol_{CO2}/g_{sorbent}) versus pressure (bar) for an ionic liquid (EMIm-TfO), a bulk MIC ingot, and MIC microparticles.

### DETAILED DESCRIPTION

Properties relevant to separations of gas mixtures include 1) selectivity—the ability to isolate the target gas over other gases in the stream, 2) capacity—the amount of gas absorbed (separated) from the gas stream relative to the amount of sorbent material, 3) regeneration—the ability to quickly, efficiently release (desorb) the target gas through pressure, vacuum or temperature swings to restore the material to initial conditions, and 4) stability—the sorbent material must withstand 100-1000's of regeneration cycles with minimal impact to sorbent performance. Gas separations are achieved through cryogenic distillation, adsorption, absorption and membrane separation, with the first three processes most commercially implemented. Cryogenic distillation suffers from high capital costs, high energy consumption, and difficulty achieving desired purity. Membrane separation faces trade-offs between permeation rate and selectivity, as well as challenges related to fouling, scalability, and implementation. Adsorbents such as zeolites offer some advantages but typically exhibit high energy requirements for regeneration and limited capacity and selectivity because sorption occurs primarily at particle surfaces.

Absorbent-based technologies represent an area of significant potential. In these systems, a mixed gas stream is passed through an absorbent material contained in a vessel or packed bed column, where the target gas is absorbed. Once the absorbent reaches capacity, the gas stream is diverted to another vessel while the saturated absorbent is regenerated and the captured gas is recovered. Aqueous absorption systems, such as commercial amines (e.g., monoethanolamine), are widely used for CO₂ capture but suffer from volatility, corrosiveness, and high regeneration energy requirements due to large heats of reaction and vaporization and the high heat capacity of water. Liquid absorbent systems also face limitations in gas throughput and often require high operating pressures. Such issues that can be mitigated by employing solid absorbents.

To address the technical limitations of existing materials and processes, the present inventors have discovered stable and highly selective CO₂-capture sorbents fabricated through the creation of polymer-ionic composite particles using ionic liquids (IL). Ionic liquids are solvent-free liquids at room temperature and comprise anions and cations, have negligible vapor pressure, relatively fast CO₂ transport, and high thermal stability. Since ILs physically trap CO₂, they have a low sorption enthalpy and low regeneration energy requirement. Drawbacks of ILs are low sorption enthalpy compared to commercially available amine sorbents, high initial cost and high viscosity. Encapsulation of ionic liquids enhances IL efficiency by increasing the active surface area, improving the absorption kinetics and gas flux, but creates active material volume limitations due to capsule shells and potential capsule rupture.

Water-soluble, rigid polyelectrolyte aramid polymers, such as poly-2,2′-disulfonyl-4,4′benzidine terephthalamide (PBDT) and the like, can form a rigid double-helix, sulfonated aromatic polyaramid, and self-assemble with nearly any kind of IL into a supramolecular structured film with fast molecular transport and high mechanical strength. These modular solid electrolyte materials are termed molecular ionic composites (MICs), bound together through a collective electrostatic network between the IL and the charged, rigid PBDT. Depending on the PBDT loading, the MIC can act as a flexible solid at low concentrations (~3 wt %) and as a tough film with mechanical modulus up to 3 GPa at ~20 wt %. MIC films are chemically resistant to many solvents, unaffected by water immersion, and stable under thermal cycling. MIC fabrication through emulsion processing techniques can create particles with similar film properties, thus, eliminating the need for a shell.

Thus the sorbents described herein can address the technical challenges described above for current CO₂-capture systems. CO₂ gas selectivity, sorption capacity and energy-efficient regeneration is achievable with polymer-based molecular ionic composite (MIC) microparticles. The particle stability provide materials for use in a packed-bed flow-through system for gas absorption. In a further advantageous feature, ionic liquid selection and controlled particle size and morphology fabrication can provide tunable gas-sorption properties. A significant improvement is therefore provided by the present disclosure.

Accordingly, an aspect of the present disclosure is a composition comprising a plurality of composite microparticles. As used herein, “composite microparticles” may also be referred to as “MIC microparticles” or “MIC particles”.

Each microparticle comprises a sulfonated polyaramid and an ionic liquid.

The sulfonated polyaramid can be a rigid rod polymer material. The sulfonated polyaramid comprises aramid repeating units of the general structure

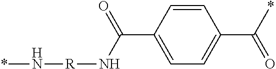

wherein R is a substituted or unsubstituted C₆₋₂₀ aromatic group, provided that at least a portion of the R groups are sulfonated (i.e., include —SO₃H or SO₃⁻ substituted groups).

In an aspect, the sulfonated polyaramid can comprise poly(2,2′-disulfonyl-4,4′-benzidine terephthalamide), a substituted poly(2,2′-disulfonyl-4,4′-benzidine terephthalamide), a chemically modified poly(2,2′-disulfonyl-4,4′-benzidine terephthalamide), and combinations thereof. In an aspect, the sulfonated polyaramid can comprise poly(2,2′-disulfonyl-4,4′-benzidine terephthalamide), which comprises repeating units having the structure

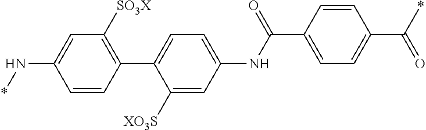

wherein X is hydrogen or an alkali metal.

The sulfonated polyaramid may be in the form of nanofibrils, which can have an average fibril diameter in the range of, for example, 1 to 30 nanometers (nm). In an aspect, the weight average molecular weight of the sulfonated aramid can be 100 to 10,000,000 grams per mole (g/mol), or 100 to 1,000,000 g/mol, or 100 to 100,000 g/mol, or 100 to 10,000 g/mol, or 10,000 to 10,000,000 g/mol, or 10,000 to 1,000,000 g/mol, or 10,000 to 100,000 g/mol, or 100,000 to 10,000,000 g/mol, or 100,000 to 1,000,000 g/mol. In a specific aspect, the sulfonated polyaramid can have a weight average molecular weight of 2,000 to 100,000 grams per mole, or 2,000 to 75,000 grams per mole, or 2,000 to 50,000 grams per mole, or 2,000 to 30,000 grams per mole. Molecular weight of the sulfonated polyaramid can be determined according to methods that are generally known, for example using sulfuric-acid-phase gel permeation chromatography coupled with capillary viscometry to determine relative molecular weight once the GPC benchmark is determined.

In some aspects, the sulfonated polyaramid is provided as an alkali metal salt, for example wherein X in the above formula is an alkali metal. The alkali metal can be, for example, sodium, lithium, potassium, cesium, or a combination thereof. In an aspect, the alkali metal can be sodium. In some aspects, the sulfonated polyaramid is provided as metal salt comprising a divalent metal cation. Exemplary divalent metal cations can include, but are not limited to, zinc, magnesium, calcium, barium, or a combination thereof.

The sulfonated polyaramid is present in the composite microparticle in an amount of 1 to 30 weight percent, based on the total weight of the composite microparticle. Within this range, the sulfonated polyaramid can be present in an amount of at least 2 weight percent, or at least 5 weight percent, or at least 8 weight percent, or at least 10 weight percent, or at least 15 weight percent, each based on the total weight of the composite microparticle. Also within this range, the sulfonated polyaramid can be present in an amount of at most 27 weight percent, or at most 25 weight percent, or at most 22 weight percent, or at most 20 weight percent, each based on the total weight of the composite microparticle.

In addition to the sulfonated polyaramid, each composite microparticle further comprises an ionic liquid, for example a room temperature ionic liquid. Ionic liquids, also referred to as molten salts because they are liquid at room temperature, e.g., 23 ° C, can have low volatility, for example a vapor pressure of less than 10⁻⁵ Pascal (Pa), or 10⁻¹⁰ to 10⁻⁵ Pa at a temperature of 23 °C.

The ionic liquid includes an anion component and a cation component. The anion of the ionic liquid can include, but is not limited to, one or more of halide, sulfate, sulfonate, carbonate, bicarbonate, phosphate, nitrate, acetate, PF₆, BF₄, trifluoromethanesulfonate (triflate), nonaflate, bis(trifluoromethylsulfonyl)amide, bis(trifluoromethanesulfonyl)imide, trifluoroacetate, heptafluorobutanoate, haloaluminate, triazolide, or an amino acid derivative (e.g., proline with the proton on the nitrogen removed). The cation of the ionic liquid can include, but is not limited to, one or more of imidazolium, pyridinium, pyrrolidinium, phosphonium, ammonium, sulfonium, thiazolium, pyrazolium, piperidinium, triazolium, oxazolium, guanidinium, an alkali cation, or dialkylmorpholinium. In some aspects, the cation can be imidazolium, pyridinium, pyrrolidinium, or an alkylated derivative thereof, for example, wherein the cation is alkylated with a C₁₋₁₂ alkyl group (e.g., ethyl, propyl, butyl, hexyl, or the like). In an aspect, the room temperature ionic liquid includes an imidazolium as a cation component. In an aspect, the room temperature ionic liquid includes 1-ethyl-3-methylimidazolium (“Emim”) or 1-butyl-3-methylimidazolium (“Bmim”) as a cation component. In an aspect, the room temperature ionic liquid includes trifluoromethanesulfonate (“TfO”), acetate, or bis(trifluoromethylsulfonyl)imide (“TFSI”) as an anion component. In an aspect, the room temperature ionic liquid includes 1-ethyl-3-methylimidazolium trifluoromethanesulfonate (“[Emim] [TfO]”), 1-ethyl-3-methylimidazolium acetate (“[Emim] [Ac]”), 1-ethyl-3-methylimidazolium bis(trifluoromethylsulfonyl)imide (“[Emim] [TFSI]”), 1-butyl-3-methylimidazolium trifluoromethanesulfonate (“[Bmim] [TfO]”), 1-butyl-3-methylimidazolium acetate (“[Bmim] [Ac]”), or 1-butyl-3-methylimidazolium bis(trifluoromethylsulfonyl)imide (“[Bmim] [TFSI]”).

The ionic liquid can be present in the composite microparticle in an amount of 70 to 99 weight percent, based on the total weight of the composite microparticle. Within this range, the ionic liquid can be present in an amount of at least 75 weight percent, or at least 78 weight percent, or at least 80 weight percent, each based on the total weight of the composite microparticle. Also within this range, the ionic liquid can be present in an amount of at most 95 weight percent, or at most 90 weight percent, or at most 85 weight percent, each based on the total weight of the composite microparticle.

In an aspect, the composite microparticle can optionally further comprise a solvent, for example water. When present, the solvent (or water) is present in the composite microparticle in a weight of less than 30 weight percent, or less than 20 weight percent, or less than 15 weight percent, or less than 12 weight percent, or less than 10 weight percent, or less than 8 weight percent, each based on the total weight of the composite microparticle.

In some aspects, the composite microparticle can optionally further comprise residual surfactant, for example depending on whether surfactants were used in the method of manufacturing the particles. Any residual surfactant can be present in an amount of 1 weight percent or less, based on the total weight of the composite microparticle.

The composite microparticles comprising the sulfonated aramid and the ionic liquid can generally be of any shape, but preferably are spherical. The microparticles can have an average diameter (or longest cross-sectional dimension for non-spherical particles) of 10 nanometers to 10 millimeters, for example 100 nanometers to 10 millimeters, or 10 nanometers to 1 millimeter, or 100 nanometers to 1 millimeter, or 100 nanometers to 100 micrometers. Particle size can be determined, for example, using optical microscopy or dynamic light scattering methods.

In some aspects, the composite microparticles can have tensile storage modulus (E′) of at least 1 GPa at 25 °C. The composite microparticles also exhibit good thermal stability, for example up to temperature of 300 ° C, or up to 250 ° C, or up to 200 °C.

In a specific aspect, the composition of the present disclosure can comprise a plurality of composite microparticles wherein each composite microparticle comprises 5 to 25 weight percent of the sulfonated polyaramid and 75 to 95 weight percent of the ionic liquid. The sulfonated polyaramid can comprise poly(2,2′-disulfonyl-4,4′-benzidine terephthalamide). The ionic liquid can comprise 1-ethyl-3-methylimidazolium trifluoromethanesulfonate, 1-ethyl-3-methylimidazolium acetate, 1-ethyl-3-methylimidazolium bis(trifluoromethylsulfonyl)imide, 1-butyl-3-methylimidazolium trifluoromethanesulfonate, 1-butyl-3-methylimidazolium acetate, or 1-butyl-3-methylimidazolium bis(trifluoromethylsulfonyl)imide. Each microparticle can have an average diameter of 10 nanometers to 10 millimeters. Each composite microparticle of the plurality of composite microparticles can comprise less than 15 weight percent of water, preferably less than 12 weight percent water, more preferably less than 10 weight percent water.

A method for the manufacture of the composition represents another aspect of the present disclosure. The method can comprise a reverse-phase emulsion method. In an aspect, the method can comprise heating a composite hydrogel comprising the sulfonated polyaramid, the ionic liquid, and water to a temperature effective to fluidize the composite hydrogel. In some aspects, a water-miscible solvent can be used in place of, or in combination with the water to prepare the hydrogel. Exemplary water miscible solvents can include but are not limited to dimethyl formamide, dimethyl sulfoxide, and the like, or a combination thereof.

The temperature effective to fluidize the composite hydrogel can be, for example, at least 50 ° C, or 50 to 100 ° C, or 50 to 80 ° C, or 50 to 75 ° C, or 50 to 70 ° C, or 60 to 70 °C. In a specific aspect, the temperature effective to fluidize the composite hydrogel can be at least 65 ° C, preferably 65 to 95 °C.

The composite hydrogel can be, for example, as described in U.S. Publication No. 2025/0171597, the contents of which are hereby incorporated by reference herein in their entirety. In an aspect, the composite hydrogel can comprise 0.05 to 20 weight percent of the sulfonated polyaramid; 0.05 to 20 weight percent of the ionic liquid; and 70 to 99.9 weight percent water, wherein weight percent is based on the total weight of the composite hydrogel

Once the composite hydrogel is provided in a fluid state, the fluidized hydrogel can be combined with an organic phase under conditions effective to provide an emulsion. In some aspects, the organic phase can preferably be pre-heated to a temperature matching the temperature of the heated fluidized hydrogel. The mixture can be agitated or stirred, for example using a stir bar, an overhead stirrer, a rotor-stator homogenizer, a sonicator, or any other suitable mixing means. Preferably a high stir rate can be used, for example a rate of about 1100 rpm.

The fluidized hydrogel can be added dropwise (e.g., using a pipette or syringe pump). In some aspects, the fluidized hydrogel can be poured into the organic phase. Other means of combining the fluidized hydrogel with the organic phase can include spraying, or any other suitable liquid transfer means.

The emulsion comprises a dispersed phase comprising the fluidized composite hydrogel and a continuous phase comprising the organic phase. The organic phase comprises an organic solvent and optionally, a surfactant.

The organic solvent can generally be any organic solvent that is not miscible with water. In some aspects, it can be advantageous to select an organic solvent having a boiling point less than 100 ° C to facilitate removal. Preferably, the solvent is non-polar and hydrophobic. Exemplary solvents can include, but are not limited to, cyclohexane, toluene, xylene, hexanes, or a combination thereof. In a specific aspect, the solvent can comprise cyclohexane.

When present, surfactants are not particularly limited, and can be anionic, cationic, or nonionic surfactants. In an aspect, the surfactant can comprise a nonionic surfactant. Exemplary nonionic surfactants include, but are not limited to, polyoxyalkylene alkyl ethers and polyoxyalkylene alkylphenyl ethers (e.g., diethylene glycol monoethyl ether, diethylene glycol diethyl ether, polyoxyethylene lauryl ether, polyoxyethylene stearyl ether, and polyoxyethylene nonylphenyl ether); oxyethylene-oxypropylene block copolymers; sorbitan fatty acid esters (e.g., sorbitan monolaurate available as SPAN 20, sorbitan monooleate available as SPAN 80, and sorbitan trioleate available as SPAN 85); polyoxyethylene sorbitan fatty acid esters (e.g., polyoxyethylene sorbitan monolaurate available as TWEEN 20 and TWEEN 21, polyoxyethylene sorbitan monopalmitate available as TWEEN 40, polyoxyethylene sorbitan monostearate available as TWEEN 60, TWEEN 60K, and TWEEN 61, polyoxyethylene sorbitan monooleate available as TWEEN 80, TWEEN 80K, and TWEEN 81, and polyoxyethylene sorbitan trioleate available as TWEEN 85); polyoxyethylene sorbitol fatty acid esters (e.g., tetraoleic acid polyoxyethylene sorbitol); glycerin fatty acid esters (e.g., glycerol monooleate); polyoxyethylene glycerin fatty acid esters (e.g., monostearic acid polyoxyethylene glycerin and monooleic acid polyoxyethylene glycerin); polyoxyethylene fatty acid esters (e.g., polyethylene glycol monolaurate and polyeth ylene glycol monooleate); polyoxyethylene alkylamine; and acetylene glycols.

When present, the surfactant can be included in the organic phase in an amount of 0.1 to 10 weight percent, based on the total weight of the organic phase. Within this range, the surfactant can be present in an amount of 1 to 5 weight percent.

The method further comprises cooling the emulsion to a temperature that is less than the temperature required to fluidize the hydrogel. For example, if the hydrogel was heated to a temperate of at least 65 ° C to fluidize the hydrogel, then the emulsion is cooled to a temperature of less than 65 ° C, for example to a temperature of 0 to less than 65 ° C, or 0 to 50 ° C, or 0 to 25 °C. Upon cooling the emulsion, hydrogel particles (e.g., comprising the sulfonated polyaramid, the ionic liquid, and water) can form. Preferably, the cooling can be rapid. Cooling the emulsion is effective to solidify the hydrogel particles, which can be separated from the cooled mixture.

The method further comprises isolating the formed hydrogel particles from the emulsion. The isolating can generally be by any solid-liquid separation technique, for example filtration, centrifugation, or the like. The method can optionally further comprise washing the isolated hydrogel particles with the organic solvent to remove excess surfactant. The washing can be repeated any suitable number of times until a desired level of removal of the surfactant is reached. In some aspects, the washing can be repeated 2 to 4 times.

The isolated hydrogel particles can have an average diameter of, for example, greater than 100 micrometers, for example greater than 100 micrometers to 1000 micrometers.

The method further comprises exposing the hydrogel particles to an excess of ionic liquid. Soaking the hydrogel particles in the ionic liquid can facilitate removal of the water from the hydrogel particles (e.g., by diffusion), thereby forming the composite microparticles. In some aspects, the hydrogel particles can be soaked in the ionic liquid at a 1:1 weight ratio at a temperature of 25° for 24 hours or more or until equilibrium is reached. Other weight ratios of ionic liquid: hydrogel particles can be used, and can be selected based on the desired final concentration of ionic liquid in the final MIC particle. Typically, the ionic liquid will be the same as the ionic liquid that was used to prepare the hydrogel particles, however this is not required, and use of ionic liquids different from what was used to prepare the hydrogel particles are also contemplated by the present disclosure. The resulting microparticles preferably comprise no more than 30 weight percent water based on the total weight of the microparticle, and have an average diameter that is smaller than the average diameter of the hydrogel particle.

The microparticles can be isolated by any suitable solid-liquid separation technique, for example by filtration to remove excess ionic liquid and water from the particles. Centrifugation is also contemplated. Optionally, the particles may be washed, for example with water, an alcohol solvent such as isopropyl alcohol, or acetone to remove excess ionic liquid. The filtered and washed particles can be allowed to dry. Drying can be air drying at room temperature (e.g., 25 ° C) or in an oven at elevated temperature (e.g., 50 ° C or more).

The composition comprising the microparticles described herein can be particularly useful for capturing a target gas. Accordingly, a method of capturing a target gas from a gas stream represents another aspect of the present disclosure. The method comprises exposing an input gas stream comprising the target gas to the composition comprising the composite microparticles. Exposing the input gas to the composition can comprise flowing the input gas stream over or through the composition. After contact with the composition, a product gas stream is provided, wherein the product gas stream has a concentration of the target gas that is less than the concentration of the target gas in the input gas stream.

The target gas is a gas which can be trapped by or interact with the ionic liquid of the composite particle, such that the target gas is absorbed by the composite particle. The target gas can be, for example, an acidic gas (e.g., CO₂, SO₂, NO, NO₂, H₂S, HF, or HCl); toxic industrial gases (e.g., phosgene (COCl₂), Cl₂, Br₂, HCN, or NH₃); water vapor; or a combination thereof. In a specific aspect, the target gas comprises carbon dioxide.

Gas streams suitable for treatment in accordance with the present disclosure may originate from a variety of industrial, environmental, or natural sources. Exemplary sources include combustion effluents, such as flue gas generated from coal-, oil-, biomass-, or natural gas-fired power plants, flue gas generated from steel mills, and flue gas generated from cement plants, which typically contain carbon dioxide, sulfur oxides, nitrogen oxides, and hydrogen halides. Additional gas streams may be derived from natural gas or biogas production, which can comprise significant concentrations of carbon dioxide, hydrogen sulfide, carbonyl sulfide, and volatile hydrocarbons. Refinery off-gases and petrochemical process streams may likewise contain hydrogen sulfide, mercaptans, ammonia, and carbon dioxide. Further examples of relevant gas streams include emissions from chemical manufacturing operations, such as chlorine, bromine, sulfur dioxide, phosgene, or ammonia released during chlorination, halogenation, or smelting processes. Still further examples include gas mixtures associated with agricultural or environmental sources, such as ammonia from fertilizer use or livestock operations, or carbon dioxide and nitrogen oxides from ambient air. In another embodiment, the gas stream may be derived from a human-occupying environment, such as a closed or recirculating air system in a spacecraft, submarine, or underwater breathing apparatus, where removal of carbon dioxide is advantageous to provide a purified and recycled breathable air supply.

In an aspect, the composition can be disposed in a packed bed column. The packed bed column can include a gas inlet capable of receiving the input gas stream, and a gas outlet where the product gas stream can be removed from the column. The packed bed column can be at least partially filled with the composition. The gas stream can optionally be continuously supplied to the packed bed column and the product gas can be continuously removed from the packed bed column.

Advantageously, the composition can be regenerated by triggering release of the captured target gas. Thus the method can further comprise regenerating the composition. Regenerating the composition can be by heating the composition to a temperature effective to release the target gas. The temperature effective to release the target gas can be, for example, at least 50 ° C and less than a decomposition temperature of the composite microparticles of the composition. In an aspect, the temperature can be greater than or equal to 50 to less than 300 ° C, or greater than or equal to 50 to less than 250 ° C, or greater than or equal to 50 to less than 200 °C. Released target gas can optionally be provided to a target gas reservoir or storage tank.

The temperature of the composition can be raised by various methods, such as steam application to the column comprising the composition or regenerated or waste heat from a power plant. In some aspects, the packed bed column may be jacketed to enable uniform application of heat to the column.

In some aspects, regenerating the composition can comprise subjecting the composition to reduced pressure (i.e., vacuum) at ambient temperature to release the target gas from the composition.

Another aspect of the present disclosure is a gas separation system. The gas separation system can include a column comprising a gas inlet at a first end and a gas outlet at the second, opposite end of the column. The column can be a packed bed column that is at least partially filled with the composition according to the present disclosure.

For example, in an aspect, a gas separation system can comprise the packed bed column comprising the composition in fluid communication with a gas inlet and a gas outlet. The gas inlet is configured to receive an input gas stream. In some aspects, the input gas stream can be stored in a source gas tank or reservoir configured to deliver the input gas stream to the inlet of the packed bed column. In some aspects, the gas inlet can be associated with a distributor positioned at or near the inlet to promote uniform distribution of the input gas stream across a cross-section of the packed bed column. The packed bed column comprises an elongated vessel containing the composition and enabling selective removal of a target gas from the input gas stream. In some aspects, a packing retainer can be disposed in the column, for example at or near the gas outlet, to secure the packing composition while permitting gas flow. The gas outlet is configured to discharged a treated gas stream (also referred to herein as the product gas stream). In some aspects, the system can optionally further comprise one or more auxiliary outlets or ports, for example for withdrawing absorbed target gas during a regeneration process, or applying vacuum during a regeneration step. A treated gas tank can be positioned downstream of and in fluid communication with the gas outlet of the packed bed column to receive and store the purified or treated gas stream. The system can further comprise a target gas tank in fluid communication with the packed bed column (e.g., via an auxiliary port), where the target gas tank is configured to receive a target gas that has been desorbed from the packing composition during a regeneration process. In some aspects, the system can further comprise a heating means configured to control the temperature of the packed bed column. The heating means can include one or more heating elements disposed externally along the length of the column, embedded within the column wall, or arranged as a jacket surrounding the column. The heating elements may be electrically powered resistive heaters, circulating thermal fluids, induction coils, or other suitable devices capable of transferring heat to the packing composition. The heating means may be operated continuously or intermittently and may be controlled by a temperature sensor positioned within or adjacent to the packed bed, thereby maintaining the temperature of the packing material within a predetermined range. By controlling the temperature of the packing material, the heating means can facilitate desorption of absorbed target gas components, improve gas-solid interaction, or maintain optimal absorption efficiency during operation of the packed bed column.

This disclosure is further illustrated by the following examples, which are non-limiting.

### Examples

### Materials

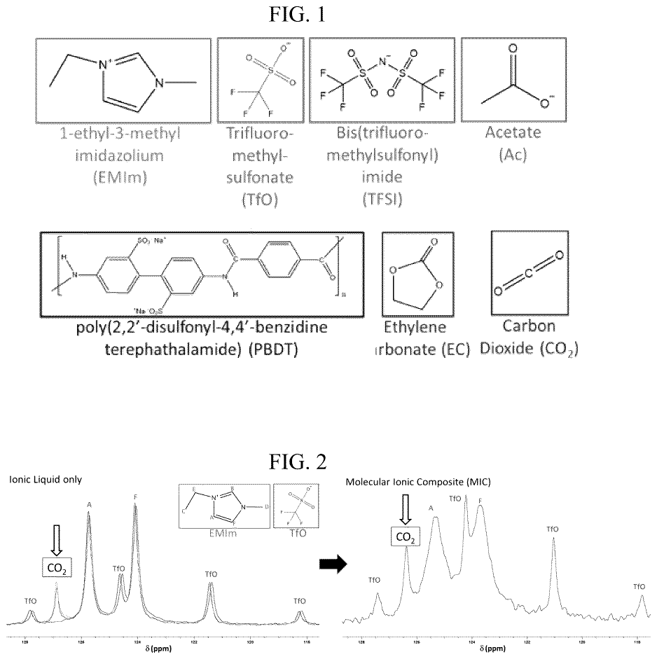

Pure ionic liquid samples were used for CO₂ measurement method development. 1-ethyl-3-methylimidazolium (EMIm) was the IL cation investigated, while the IL anion varied between trifluoromethylsulfonate (TfO), bis(trifluoromethylsulfonyl)imide (TFSI), and acetate (Ac) (FIG. 1). Copper (II) Sulfate pentahydrate (CuSO₄), chromium (III) acetylacetonate (Cr(AcAc)₃), and Gadolinium (III) trifluoromethanesulfonate (Gd(OTf)₃) were used as T₁ relaxation agents for NMR specific studies with IL and CO₂. Specific concentrations were determined for each IL based on solubility, stability and efficacy, but ranged from 1-20 mM in the IL. Initial relaxation agent trials and concentration studies were performed with ethylene carbonate (EC). 15 mM Cr(AcAc)₃ was determined to be the optimal concentration for EMIm-TfO and EMIm-TFSI, while 1.5 mM Gd(OTf)₃ performed the best with EMIm-Ac.

The rigid-rod polyelectrolyte polymer, 2,2′-disulfonyl-4,4′benzidine terephthalamide (PBDT), is a sulfonated polyaramid that forms a nematic liquid crystalline solution in water. PBDT was produced according to previously published interfacial condensation polymerization. Aqueous solutions of PBDT were made by combining 1-2 wt % PBDT with HPLC water. PBDT with a lithium counterion (Li⁺) was used with a M_{w}~17 kg/mol and an isotropic to nematic transition of 1.2-1.8 wt %. PBDT is a rare synthetic double helical structure with an aspect ratio of ~1000:1, which contributes to its high strength to weight ratio. MIC ingots, solid ionic gels, were produced in an aqueous solution based on a previously published procedure. The EMIm TFSI MIC incorporated N,N dimethylformamide (DMF) to compatibilize the IL with the aqueous PBDT solution. The MIC ingots are insoluble in water. A MIC hydrogel can be formed with a 1-2 wt % PBDT and <6 wt % IL aqueous solution when mixed together above 65 °C. As the hydrogel cools to room temperature, as solid gel appears. Unlike the MIC ingot, the hydrogel is soluble in water and will repeatedly liquify when brought above 65 °C. The addition of IL or the removal of water from the hydrogel will produce a MIC ingot. All samples were dried in a vacuum oven at 100 ° C to remove unbound water, except for the MICs made with EMIm-Ac which were dried in an oven at 100 °C.

Dry ice was used as a convenient CO₂ source for IL and MIC doping and quantitative analysis of the MIC sorption. ILs, MICs, and MIC particles were added to thicker-walled NMR tubes capable of withstanding high pressures (≤15 bar). With the NMR sample frozen, a chip of dry ice was added to the NMR tube and quickly flame sealed. Mass gain of the sealed NMR sample from the addition of the dry ice chip was recorded after equilibrating to room temperature. NMR quantification measured the amount of CO₂ absorbed into the IL or MIC, with the remainder in the gas phase. Assuming ideal gas laws, estimated NMR pressure calculations were made. Labeled (13CO₂) will be used to quantify lower CO₂ loadings at atmospheric pressures with the construction of a doping manifold.

### CO₂ Loading Process

Investigating the ideal concentration and relaxation agent for CO₂ in pure ILs required the development of a doping method. For proof of concept evaluation, dry ice was used as a convenient CO₂ source. ILs and MICs were added to thicker-walled NMR tubes capable of withstanding high pressures (≤15 bar). With the NMR sample frozen, a chip of dry ice was added to the NMR tube and quickly flame sealed. Mass gain of the sealed NMR sample from the addition of the dry ice chip was recorded after equilibrating to room temperature. NMR quantification measured the amount of CO₂ absorbed into the IL or MIC, with the remainder in the gas phase. Assuming ideal gas laws, estimated NMR pressure calculations were made.

### NMR Methods

Quantitative ¹³C NMR (Q_{NMR}) was used to determine the molar concentration of CO₂ absorbed into the IL and the MIC, and measure changes to chemical shifts (8c) from varying molecular environments. Pulsed-field-gradient (PFG) NMR “diffusometry” was used to quantify the diffusion coefficients of each species (IL anion & cation, CO₂, water) in the MIC particles under varied conditions. Lacking protons, only ¹³C NMR was used for CO₂, which has the challenge of low signal due to (1) low gyromagnetic ratio, γ_{C}, at 25% that of a proton, (2) low natural abundance (1.1%), and (3) no Nuclear Overhauser Effect (NOE) enhancement from most ¹³C nuclear sites that have protons attached. EC was used as a proof of concept, since it was easily incorporated and its two proton-containing carbons could be used to verify ¹³C diffusion coefficient determination. Labeled ¹³CO₂ is available for purchase to improve signal strength, but is expensive and challenging to incorporate. CO₂ has long T₁ relaxation times of 25-50s, which requires NMR signal collection durations per sample of a day or more. The incorporation of relaxation agents can reduce T₁ times and, subsequently, overall signal collection times. T₁ relaxation agents are commonly used in biological applications, specifically in MRIs where they are termed contrast agents. T₁ relaxation agents also shortens T₂*, the transverse relaxation, which broadens the spectral line width. NMR T₁ inversion recovery (T1ir) was performed on all IL and MIC samples to determine the effect of the relaxation agent on the loaded CO₂ signal's rate of return to maximum net magnetization (or signal). T₁ values are crucial for establishing optimum PFG experiments by maximizing both signal to noise and total experimental time to obtain consistent, accurate diffusion coefficients.

NMR diffusometry and T1ir measurements were performed at 20.9±0.4 ° C on a Bruker Avance III 400 MHz/9.4 T wide bore spectrometer equipped with a high gradient diffusion probe (Diff50) with a 5 mm ¹H/¹³C R.F. coil insert. Q_{NMR} measurements were done on a 600 MHz Bruker NMR spectrometer with a cryroprobe. Acquisition parameters for the ¹³C Q_{NMR} measurements using relaxation agents were AQ=0.2-0.5s, D1=1-2s, and NS=128-512 for ILs and 2400 or higher for MICs. Acquisition parameters were chosen to maximize signal-to-noise within each sample. Decoupling was used (zgpg) for ¹³C Q_{NMR} to minimize CO₂ signal overlap, but analysis was performed against carbons that did not experience cross-relaxation NOE, such as the triflates or carboxyl group on the acetate. Similar settings were used for T1irpg experiments with decoupling to isolate the CO₂ δ_{c}. CO₂ T₁ values ranged from 100 ms to 1.3s depending on the relaxation agent and concentration employed. ¹³C NMR Diffusometry experiments used g ranging from 1100-1800 G/cm, δ=1 ms, Δ=25-50 ms, and NS=512-1024 for IL and 2400-3600 for MIC. The values of the diffusion encoding parameters within these ranges depend on the IL type and were selected to achieve ≥85% signal attenuation. The repetition time, Tᵣ, was approximately 2-3 times the T₁ value. ¹H Q_{NMR} and Diffusometry NMR measurements were also performed.

### NMR Material Evaluation

Material fabrication and CO₂-doping for NMR method evaluation were performed in stages. Model systems including the solvent EC and pure ILs were initially used for proof of feasibility evaluations in lieu of CO₂. EC has a carbonyl centered carbon isolated from any protons similar to CO₂, in addition to two proton-containing carbons. Thus, EC was used to determine signal-to-noise ratios and detection limits in IL and MICs, since both ¹H and ¹³C NMR can be measured. A major insight and achievement from this analysis was to incorporate paramagnetic T₁ relaxation agents to reduce T₁ times and, by extension, overall signal collection times from days to minutes. With the incorporation of relaxation agents into EC-doped ILs, an order of magnitude reduction of ¹³C NMR T₁ times was observed. Relaxation agent concentration and efficacy also depends on the hydrophobic nature of the IL and its interaction with CO₂, which was compensated by tailoring the relaxation agent to the specific IL composition.

Neat ILs were used to verify diffusion coefficients obtained from NMR Diffusometry compared to literature reported values, which was followed by confirmation that diffusion coefficients were unaffected by the addition of relaxation agents. Investigating the ideal concentration and relaxation agent for CO₂ in pure ILs required the development of a doping method described in the Methods section. Q_{NMR} was performed to measure the molar concentration of CO₂ absorbed into the IL or MIC. 15 mM Cr(AcAc)₃ was determined to be the optimal relaxation agent loading in EMImTfO, a hydrophobic IL. FIG. 2 illustrates the use of Q_{NMR} to determine the molar concentration of CO₂ in both the IL and MIC samples. MICs exhibit line broadening from shortened transverse relaxation, T₂*, in the solid sample that adds to the CO₂ quantification challenge that can be addressed with more data acquisition (longer experimental times) and labeled CO₂ (expensive).

T₁ relaxation data was important in determining the optimum choice and loading of relaxation agent for each IL and MIC system. Relaxation agent solubility is critical for incorporation into the MICs, otherwise the material will be filtered out during the MIC fabrication process. The effect of the concentration of Cr(AcAc)₃ in EMImTfO on NMR T₁ relaxation rates in the liquid (IL) and solid (MIC) phases was explored, and increasing Cr(AcAc)₃ concentration was observed to reduce T₁, but increase line broadening which reduces the resolution between peaks. Lower CO₂ loadings does reduce T₁, increasing the data acquisition per unit time. However, this benefit is offset as T₁ increases with the transition from a liquid (IL) to a solid (MIC) phase at the same CO₂ loading. These are important considerations for maximizing NMR quantification and diffusometry measurements.

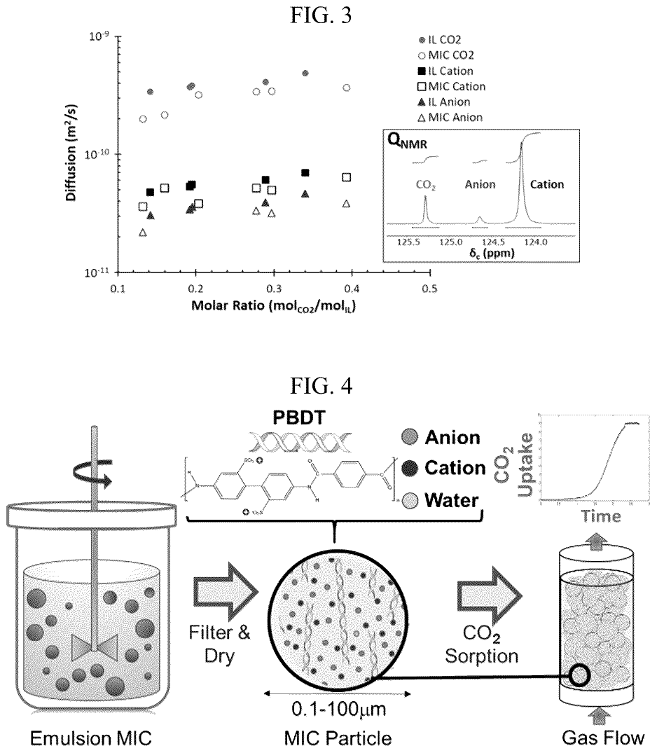

FIG. 3 shows preliminary diffusion data of CO₂-loaded EMImTfO samples comparing the transport of each chemically specific species in both the pure liquid phase (the IL) and the solid phase MIC. CO₂ diffusion is only modestly reduced (<50%) by confining the IL in the solid MIC. This result demonstrates that CO₂ transport and absorption is only weakly affected by changing from the liquid-phase IL system to the solid-phase MIC system, thus opening new modes for solid-phase CO₂ capture and separations with MIC particles.

### MIC Particle Production

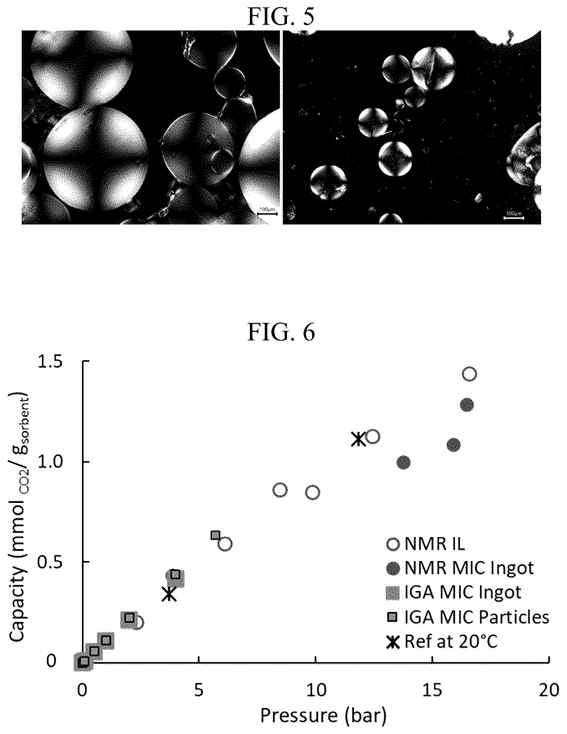

Fabrication of MIC particles entailed a reverse-phase emulsion processing method to a create water-in-oil emulsion where IL and PBDT are dispersed in the discontinuous water phase, as shown schematically in FIG. 4. Emulsifying agents maintain droplet size and stabilize the emulsion. The discontinuous, aqueous phase consisted of a MIC hydrogel heated to ≥65 ° C, where it was a fluid. The hydrogel contained 1 wt % PBDT and 4.8 wt % EMImTfO in HPLC water. Cyclohexane, an immiscible non-polar solvent, with 1.6 wt % sorbitan monooleate (Span80), a lipophilic surfactant, was the continuous phase. Other immiscible non-polar solvents, such as toluene, xylene and hexanes, can be used, but cyclohexane was selected due to its boiling point below water. Other sorbitans or polysorbates, hydrophilic ethoxylated sorbitan esters, are other emulsifying agent alternatives. The volume ratio was ~3:1 non-polar, continuous phase: aqueous, discontinuous phase. The continuous phase was mixed with a stirrer bar on a magnetic mixing plate in a ≥65 ° C heated water bath. The hot hydrogel was added to the heated, stirred continuous phase, producing a transparent mixed solution. The hot water bath was replaced with chilled water. The mixed solution then became opaque. With time, the mixture separated into a solvent rich top layer (cyclohexane) and a particle rich bottom layer (MIC hydrogel particles). The solvent layer was removed, and the MIC hydrogel particles were washed with cyclohexane to remove excess Span80 (FIG. 5, left). The MIC hydrogel particles were soaked in IL to produce the final MIC particles, which are impervious to water (FIG. 5, right).

Table 1 provides a summary of materials and results for two examples prepared according to the process described herein.

| | | Example 1 | Example 2 |
|---|---|---|---|
| | | Weight | Weight |
| Component | Material | Percent¹ | Percent¹ |
| Continuous | Cyclohexane | 98.4 | 98.4 |
| Oil Phase | SPAN-80 | 1.6 | 1.6 |
| Hydrogel | PBDT | 0.95 | 1.09 |
| | Water | 94.35 | 95.4 |
| | Emim-TfO | 1.389 | 3.51 |
| Reverse Phase | Continuous Oil Phase | 70.1 | 68.7 |
| Emulsion | Hydrogel | 29.9 | 31.3 |
| Ionic Liquid | Particles | 53.2 | 50.9 |
| Soaking | Emim-TfO 15 mM | 46.8 | 49.1 |
| | Cr(AcAc)₃ solution | | |
| Dried Particles | PBDT (theoretical) | 6.2 | 19.2 |

¹All weight percents in the ‘Hydrogel’ block are based on total hydrogel weight; all weight percents in the ‘Continuous Oil Phase’ block are based on total oil phase weight; all weight percents in the ‘Reverse Phase Emulsion’ block are based on total reverse phase emulsion weight; all weight percents in the ‘Ionic Liquid Soaking’ block are based on total weight of particles and IL solution.

Proof-of-concept experiments were conducted to evaluate the ability of the compositions described herein to absorb carbon dioxide (CO₂). CO₂ uptake was quantified for (i) a precursor ionic liquid (IL), (ii) a bulk molecular ionic composite (MIC) ingot formed from the same IL and sulfonated polyaramid, and (iii) MIC microparticles produced by the emulsion-based fabrication methods described herein. Two independent measurement techniques were employed to assess CO₂ absorption behavior across these material formats: quantitative nuclear magnetic resonance (NMR) spectroscopy and conventional gravimetric gas absorption analysis.

CO₂ absorption capacity was determined as a function of pressure at a temperature of 25 ° C using both techniques and results are shown in FIG. 6. For NMR measurements, samples of the ionic liquid (1-ethyl-3-methylimidazolium trifluoromethanesulfonate, EMIm-TfO), the bulk MIC ingot, and MIC microparticles were loaded into pressure-resistant NMR tubes and doped with unlabeled CO₂ generated from dry ice. The use of unlabeled CO₂ required elevated pressures to achieve acceptable signal-to-noise ratios. Quantitative ¹³C NMR analysis was used to determine the amount of CO₂ absorbed into each sample.

Gravimetric CO₂ absorption measurements were performed using an Intelligent Gravimetric Analyzer (IGA). The IGA measurements provided CO₂ uptake data over a pressure range extending from sub-atmospheric conditions to approximately 7 bar, encompassing pressure regimes relevant to human exhalation streams, flue gas emissions, and building-related waste gas streams. The gravimetric data exhibited strong agreement with the NMR-derived absorption values across overlapping pressure ranges, thereby validating the NMR measurements and confirming the observed CO₂ absorption behavior.

These results collectively demonstrate that MIC microparticles fabricated using the emulsion method described herein retain CO₂ absorption characteristics comparable to those of the precursor ionic liquid, while providing the advantages associated with a solid, particulate sorbent format suitable for packed-bed and other gas separation systems.

Thus, the present emulsion-based MIC particle production process can mitigate slow gas transport without sacrificing IL filling factor or CO₂ sorption capacity as seen in conventional capsule shell materials. The lack of odor, non-volatile nature, high oxidative stability and efficiency of ILs are advantages over current sorbent systems. The physiochemical properties of MIC particles can be tuned based emulsion processing, material concentrations, and IL chemistry to positively impact CO₂ solubility and selectivity and to aid in predictive materials design. Accordingly the compositions and methods provided herein can impact net negative CO₂ absorption efforts for direct air capture, as well as other gas separation technologies for industrial applications requiring the separation of byproducts.

This disclosure further encompasses the following aspects.

Aspect 1: A composition comprising a plurality of composite microparticles, each composite microparticle of the plurality of composite microparticles comprising: 1 to 30 weight percent of a sulfonated polyaramid; and 70 to 99 weight percent of an ionic liquid; wherein weight percent is based on the total weight of the composite microparticle.

Aspect 2: The composition of aspect 1, wherein each composite particle has an average diameter of 10 nanometers to 10 millimeters.

Aspect 3: The composition of aspect 1 or 2, wherein each composite microparticle of the plurality of composite microparticles less than 30 weight percent, or less than 20 weight percent, or less than 15 weight percent, or less than 12 weight percent, or less than 10 weight percent, or less than 8 weight percent of a solvent; preferably wherein each composite microparticle of the plurality of composite microparticles less than 30 weight percent, or less than 20 weight percent, or less than 15 weight percent, or less than 12 weight percent, or less than 10 weight percent, or less than 8 weight percent of water.

Aspect 4: The composition of any of aspects 1 to 3, wherein the sulfonated polyaramid comprises poly(2,2′-disulfonyl-4,4′-benzidine terephthalamide), a substituted poly(2,2′-disulfonyl-4,4′-benzidine terephthalamide), a chemically modified poly(2,2′-disulfonyl-4,4′-benzidine terephthalamide), and combinations thereof; preferably wherein the sulfonated polyaramid comprises poly(2,2′-disulfonyl-4,4′-benzidine terephthalamide).

Aspect 5: The composition of any of aspects 1 to 4, wherein the sulfonated polyaramid has a weight average molecular weight of 2,000 to 100,000 grams per mole.

Aspect 6: The composition of any of aspects 1 to 5, wherein the sulfonated polyaramid is an alkali metal salt thereof, preferably wherein the alkali metal salt comprises sodium, lithium, potassium, cesium, or a combination thereof.

Aspect 7: The composition of any of aspects 1 to 5, wherein the sulfonated polyaramid is a metal salt thereof comprising a divalent metal cation, preferably wherein the divalent metal cation comprises zinc, magnesium, calcium, barium, or a combination thereof.

Aspect 8: The composition of any of aspects 1 to 7, wherein the ionic liquid comprises an anion component and a cation component; preferably wherein the anion component comprises halide, sulfate, sulfonate, carbonate, bicarbonate, phosphate, nitrate, nitrate, acetate, PF₆, BF₄, triflate, nonaflate, bis(trifluoromethylsulfonyl)imide, trifluoroacetate, heptafluorobutanoate, haloaluminate, or triazolide, preferably triflate; and the cation component comprises imidazolium, pyridinium, pyrrolidinium, phosphonium, ammonium, sulfonium, thiazolium, pyrazolium, piperidinium, triazolium,pyrazolium, oxazolium, guanidinium, an alkali cation, or dialkylmorpholinium, preferably imidazolium; more preferably wherein the ionic liquid comprises 1-ethyl-3-methylimidazolium trifluoromethanesulfonate, 1-ethyl-3-methylimidazolium acetate, 1-ethyl-3-methylimidazolium bis(trifluoromethylsulfonyl)imide, 1-butyl-3-methylimidazolium trifluoromethanesulfonate, 1-butyl-3-methylimidazolium acetate, or 1-butyl-3-methylimidazolium bis(trifluoromethylsulfonyl)imide.

Aspect 9: The composition of any of aspects 1 to 8, wherein each composite microparticle of the plurality of composite microparticles comprises: 5 to 25 weight percent of the alkali metal salt of the sulfonated polyaramid; and 75 to 95 weight percent of the ionic liquid.

Aspect 10: The composition of aspect 1, wherein each composite microparticle of the plurality of composite microparticles comprises: 5 to 25 weight percent of the sulfonated polyaramid; and 75 to 95 weight percent of the ionic liquid; wherein the sulfonated polyaramid comprises poly(2,2′-disulfonyl-4,4′-benzidine terephthalamide); the ionic liquid comprises 1-ethyl-3-methylimidazolium trifluoromethanesulfonate, 1-ethyl-3-methylimidazolium acetate, 1-ethyl-3-methylimidazolium bis(trifluoromethylsulfonyl)imide, 1-butyl-3-methylimidazolium trifluoromethanesulfonate, 1-butyl-3-methylimidazolium acetate, or 1-butyl-3-methylimidazolium bis(trifluoromethylsulfonyl)imide; each microparticle has an average diameter of 10 nanometers to 10 millimeters; and each composite microparticle of the plurality of composite microparticles comprises less than 15 weight percent of water.

Aspect 11: A method for the manufacture of the composition of any of aspects 1 to 10, the method comprising: heating a composite hydrogel comprising: the sulfonated polyaramid; the ionic liquid; and water; to a temperature effective to fluidize the composite hydrogel; combining the fluidized composite hydrogel with an organic phase under conditions effective to provide an emulsion comprising a dispersed phase comprising the composite hydrogel and a continuous phase comprising the organic phase; cooling the emulsion to form a dispersion of hydrogel particles; isolating the hydrogel particles from the emulsion; and exposing the hydrogel particles to an excess of ionic liquid to provide a composition comprising a plurality of composite microparticles.

Aspect 12: The method of aspect 11, wherein the composite hydrogel comprises: 0.015 to 20 weight percent of the sulfonated polyaramid; 0.5 to 20 weight percent of the ionic liquid; and 70 to 99.5 weight percent water, wherein weight percent is based on the total weight of the composite hydrogel.

Aspect 13: The method of aspects 11 or 12, wherein the organic phase comprises an organic solvent an optionally, a surfactant; preferably wherein the organic solvent comprises a non-polar solvent that is immiscible with water; more preferably wherein the organic solvent comprises cyclohexane, toluene, xylene, hexanes, or a combination thereof.

Aspect 14: The method of any of aspects 11 to 13, wherein isolating the hydrogel particles comprises separating the continuous phase from the hydrogel particles and optionally, washing the hydrogel particles.

Aspect 15: A method of capturing a target gas from an input gas stream, the method comprising: exposing the input gas stream comprising the target gas to the composition of any of aspects 1 to 10 to provide a product gas stream, wherein the product gas stream has a concentration of the target gas that is less than a concentration of the target gas in the input gas stream.

Aspect 16: The method of aspect 15, wherein the target gas comprises carbon dioxide, water, ammonia, sulfur dioxide, hydrogen sulfide, chlorine dioxide, hydrogen chloride, hydrogen fluoride, phosgene, hydrogen cyanide, methane, or a combination thereof.

Aspect 17: The method of aspect 15 or 16, wherein the input gas stream comprises a flue gas or comprises exhaled air from a human-occupied environment.

Aspect 18: The method of any of aspects 15 to 17, wherein the composition is disposed in a packed bed column comprising a gas inlet and a gas outlet.

Aspect 19: The method of aspect 18, wherein the input gas stream is continuously supplied to the packed bed column and the product gas is continuously removed from the packed bed column.

Aspect 20: The method of any of aspects 15 to 19, further comprising regenerating the composition, preferably wherein regenerating the composition comprises heating the composition to a temperature effective to release absorbed target gas from the composition; more preferably wherein the temperature is greater than or equal to 50 ° C and less than a decomposition temperature of the composite microparticles of the composition, or greater than or equal to 50 to less than 300 °C.

Aspect 21: A gas separation system comprising: a column comprising a gas inlet at a first end and a gas outlet at the second, opposite end of the column; wherein the column comprises a packed bed comprising the composition of any of aspects 1 to 10.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“−”) that is not between two letters or symbols is used to indicate a point of attachment for a substituent. For example, —CHO is attached through carbon of the carbonyl group.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂⁻), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composition comprising a plurality of composite microparticles, each composite microparticle of the plurality of composite microparticles comprising:
1 to 30 weight percent of a sulfonated polyaramid; and
70 to 99 weight percent of an ionic liquid;
wherein weight percent is based on the total weight of the composite microparticle.

2. The composition of claim 1, wherein each composite particle has an average diameter of 10 nanometers to 10 millimeters.

3. The composition of claim 1, wherein each composite microparticle of the plurality of composite microparticles comprises less than 30 weight percent of a solvent, based on the total weight of the composite microparticle.

4. The composition of claim 1, wherein the sulfonated polyaramid comprises poly(2,2′-disulfonyl-4,4′-benzidine terephthalamide), a substituted poly(2,2′-disulfonyl-4,4′-benzidine terephthalamide), a chemically modified poly(2,2′-disulfonyl-4,4′-benzidine terephthalamide), and combinations thereof.

5. The composition of claim 1, wherein the sulfonated polyaramid has a weight average molecular weight of 2,000 to 100,000 grams per mole.

6. The composition of claim 1, wherein the sulfonated polyaramid is an alkali metal salt thereof.

7. The composition of claim 1, wherein the sulfonated polyaramid is a metal salt thereof comprising a divalent metal cation.

8. The composition of claim 1, wherein the ionic liquid comprises an anion component and a cation component.

9. The composition of claim 1, wherein each composite microparticle of the plurality of composite microparticles comprises:
5 to 25 weight percent of the alkali metal salt of the sulfonated polyaramid; and
75 to 95 weight percent of the ionic liquid.

10. The composition of claim 1, wherein each composite microparticle of the plurality of composite microparticles comprises:
5 to 25 weight percent of the sulfonated polyaramid; and
75 to 95 weight percent of the ionic liquid;
wherein
the sulfonated polyaramid comprises poly(2,2′-disulfonyl-4,4′-benzidine terephthalamide);
the ionic liquid comprises 1-ethyl-3-methylimidazolium trifluoromethanesulfonate, 1-ethyl-3-methylimidazolium acetate, 1-ethyl-3-methylimidazolium bis(trifluoromethylsulfonyl)imide, 1-butyl-3-methylimidazolium trifluoromethanesulfonate, 1-butyl-3-methylimidazolium acetate, or 1-butyl-3-methylimidazolium bis(trifluoromethylsulfonyl)imide;
each microparticle has an average diameter of 10 nanometers to 10 millimeters; and
each composite microparticle of the plurality of composite microparticles comprises less than 15 weight percent of water.

11. A method for the manufacture of the composition of claim 1, the method comprising:
heating a composite hydrogel comprising:
the sulfonated polyaramid;
the ionic liquid; and
water;
to a temperature effective to fluidize the composite hydrogel;
combining the fluidized composite hydrogel with an organic phase under conditions effective to provide an emulsion comprising a dispersed phase comprising the composite hydrogel and a continuous phase comprising the organic phase;
cooling the emulsion to form a dispersion of hydrogel particles;
isolating the hydrogel particles from the emulsion; and
exposing the hydrogel particles to an excess of ionic liquid to provide a composition comprising a plurality of composite microparticles.

12. The method of claim 11, wherein the composite hydrogel comprises:
0.015 to 20 weight percent of the sulfonated polyaramid;
0.5 to 20 weight percent of the ionic liquid; and
70 to 99.5 weight percent water,
wherein weight percent is based on the total weight of the composite hydrogel.

13. The method of claim 11, wherein the organic phase comprises an organic solvent and optionally, a surfactant.

14. The method of claim 11, wherein isolating the hydrogel particles comprises separating the continuous phase from the hydrogel particles and optionally, washing the hydrogel particles.

15. A method of capturing a target gas from an input gas stream, the method comprising:
exposing the input gas stream comprising the target gas to the composition of claim 1 to provide a product gas stream, wherein the product gas stream has a concentration of the target gas that is less than a concentration of the target gas in the input gas stream; and
optionally, regenerating the composition.

16. The method of claim 15, wherein the target gas comprises carbon dioxide, water, ammonia, sulfur dioxide, hydrogen sulfide, chlorine dioxide, hydrogen chloride, hydrogen fluoride, phosgene, hydrogen cyanide, methane, or a combination thereof.

17. The method of claim 15, wherein the input gas stream comprises a flue gas or comprises exhaled air from a human-occupied environment.

18. The method of claim 15, wherein the composition is disposed in a packed bed column comprising a gas inlet and a gas outlet.

19. The method of claim 18, wherein the input gas stream is continuously supplied to the packed bed column and the product gas is continuously removed from the packed bed column.

20. A gas separation system comprising:
a column comprising a gas inlet at a first end and a gas outlet at the second, opposite end of the column;
wherein the column comprises a packed bed comprising the composition of claim 1.
